(19) United States
(12) Patent Application Publication
(10) Pub. No.: US 2009/0187434 A1
(43) Pub. Date: Jul. 23, 2009

(54) SYSTEM AND METHOD FOR A HEALTH INSURANCE RISK EVALUATOR

(75) Inventors: DAVID T. COWLES, NEEDHAM, MA (US); FRANCISCO SAMUEL, ATTLEBORO FALLS, MA (US)

Correspondence Address: AKC PATENTS, 215 GROVE ST., NEWTON, MA, 02466, US

(73) Assignee: BENEMAX, INC, MEDFIELD, MA (US)

(21) Appl. No.: 12/332,015

(22) Filed: Dec. 10, 2008

Related U.S. Application Data
(60) Provisional application No. 61/023,071, filed on Jan. 23, 2008.

(51) Int. Cl. G06Q 40/00; G06Q 90/00; G06F 3/048

(52) U.S. Cl. 705/4; 715/764

(57) ABSTRACT

A computer implemented method for selecting a health plan includes logging into a server comprising a risk evaluation application and starting the risk evaluation application. Upon being prompted by the risk evaluation application selecting a health plan for an individual or for a family. Upon being prompted by the risk evaluation application selecting an amount of upfront claims cost responsibility (CCR) willing to assume. Next, actuating a control for determining health plan premium contribution savings and then determining the health plan premium contribution savings based on the selected health plan and the selected CCR. Finally, displaying the selected CCR and the determined health plan premium contribution savings. The method empowers each user to design a unique health care plan that reflects that user's specific health profile, benefit budget and level of risk tolerance.

### CROSS REFERENCE TO RELATED CO-PENDING APPLICATIONS

This application claims the benefit of U.S. provisional application Ser. No. 61/023,071 filed on Jan. 23, 2008 and entitled SYSTEM AND METHOD FOR A HEALTH INSURANCE RISK EVALUATOR which is commonly assigned and the contents of which are expressly incorporated herein by reference.

### FIELD OF THE INVENTION

The present invention relates to a system and a method for a web-based health insurance risk evaluator.

### BACKGROUND OF THE INVENTION

Health insurance is a form of insurance used for paying medical expenses. Health insurance works by estimating the overall risk of healthcare expenses and developing a routine finance structure, such as a monthly or annual premium, that will ensure that money is available to pay for the healthcare benefits specified in the insurance policy agreement. The benefit is administered by a central organization, such as a private insurance company, a government agency or a not-for-profit entity.

The individual policy-holder's payment obligations may take the form of a premium, deductible or copayment, among others. Premium is the amount the policy-holder pays to the health plan each month to purchase health coverage. Deductible is the amount that the policy-holder must pay out-of-pocket before the health plan pays its share. For example, a policy-holder might have to pay a $500 deductible per year, before any of their health care is covered by the health plan. It may take several doctor's visits or prescription refills before the policy-holder reaches the deductible and the health plan starts to pay for care. Copayment is the amount that the policy-holder must pay out of pocket before the health plan pays for a particular visit or service. For example, a policy-holder might pay a $45 copayment for a doctor's visit, or to obtain a prescription. A copayment must be paid each time a particular service is obtained.

Health insurance is usually provided to individuals through an employer, a government-sponsored insurance program, or purchased directly by the individuals. In the case of employer provided health insurance, the employer purchases health insurance from an insurance company on a group basis and offers it to its employees. In each case, the covered groups or individuals pay premiums to help protect themselves from high or unexpected healthcare expenses. In the United States approximately 60% of the population receives health insurance through employer-sponsored plans. Government programs cover another 27% of the population, and about 9% of the population purchases insurance directly.

In recent years health care costs have increased significantly. Such increases are attributable to a number of factors, including increasingly expensive medical procedures and prescription medications and legislatively mandated benefits. Health insurance cost and availability are sources of major concern for parties responsible for medical costs and health insurance premiums, including employers who provide such benefits and their employees. Areas of concern commonly involve premiums, coverage and health care service provider choices.

Health insurers and benefit plans have responded to the rising cost of health care by raising premiums, increasing deductibles, reducing coverage levels and restricting access to health care providers. In the end, all of these strategies lead to the same result: increased cost for plan members, either through higher payroll deductions, greater out-of-pocket liability, or narrower insurance cover. What is missing is a strategy that gives employees options for designing their own benefit levels and incentives to consume health care wisely and direct rewards for improved health and fitness.

Today, most employees have little or no control over the cost or scope of their health benefits. As a result, they lack any direct incentive to seek out or negotiate favorable pricing for needed treatments or to reduce their overall consumption of health care services. Providing employees with some degree of control over their health care costs by allowing each subscriber to select a unique level of payroll deduction tied to a unique level of claims cost exposure may make a substantial contribution toward long term control of health care cost.

Systems and methods for managing aspects of healthcare accounts include flexible spending accounts (“FSAs”), health reimbursement arrangements (“HRAs”), and health savings account (“HSA”), among others. FSAs are generally healthcare accounts which are funded by pre-tax payroll deductions and setup by an employee as a means for paying for healthcare expenses not otherwise covered by the insurance carrier of the employee. A notable drawback of FSAs is that any unused portion of the funds in the account may not be rolled over to the next plan year for use by the employee. HRAs are generally healthcare accounts which receive contributions from the employer for the benefit of the employee. While monetary contributions to an HRA may be rolled over from one plan year to the succeeding plan year, if the employee terminates employment with the employer, the employer will keep the unused portions of the monetary contributions within the HRA. An HSA is generally a savings product established by the employee with a financial institution into which the employee may deposit money on a tax-preferred basis. The HSA enables an employee to pay for current uncovered healthcare expenses and/or save for future qualified medical and retiree healthcare expenses. The employee owns and controls the money in the HSA and, as such, decisions on how to spend the money within the HSA may be made by the employee without relying on a third party or a health insurer. Furthermore, the employee will also be able to decide what types of investments to make with the money in the HSA account in order to make it grow.

While such known systems and methods generally work for their intended purpose, what is still needed is a system and method for helping employees evaluate and assume a certain level of risk (i.e., deductible) in view of realizing premium contributions savings.

### SUMMARY OF THE INVENTION

The present invention describes an online system and a method for a web-based health insurance risk evaluator application.

In general, in one aspect, the invention features a computer implemented method for selecting a health plan including the following steps. First logging into a server comprising a risk evaluation application and starting the risk evaluation application. Upon being prompted by the risk evaluation application selecting a health plan for an individual or for a family. Upon being prompted by the risk evaluation application selecting an amount of upfront claims cost responsibility (CCR) willing to assume. Next, actuating a control for determining health plan premium contribution savings and then determining the health plan premium contribution savings based on the selected health plan and the selected CCR. Finally, displaying the selected CCR and the determined health plan premium contribution savings.

Implementations of this aspect of the invention may include one or more of the following features. The computer implemented method may further include accepting the selected health plan based on the determined health plan premium savings and enrolling into the selected health plan by filling out an electronic health plan enrollment form. The computer implemented method may further include rejecting the selected health plan based on the determined health plan premium savings, then selecting a different amount of upfront CCR, and then determining again the health plan premium contribution savings. The computer implemented method may further include determining eligibility for tax deductible contribution to a health savings account based on the selected CCR. The determining of the health plan premium contribution savings comprises executing an algorithm comprising a three parameter logarithmic function of the selected CCR amount. The displaying of the selected CCR and the determined health plan premium contribution savings comprise presenting a first graph depicting the selected CCR and a second graph depicting the determined health plan premium contribution savings.

In general, in another aspect, the invention features a computer system comprising a first computing device, a storage device and a computer program stored in the storage device. The computer program includes a first webpage and a second webpage adapted to be viewed by a user through a browser executing on a second computing device. The second computing device is adapted to connect to the first computing device via a network connection. The first webpage prompts the user to select a health plan that covers an individual or a family, then to select an amount of upfront claims cost responsibility (CCR) the user is willing to assume for the selected health plan and then to actuate determination of an amount of health plan premium contribution savings based on the selected health plan and the selected CCR amount. The second webpage presents a first graph to the user depicting the CCR amount and a second graph depicting the determined amount of health plan premium contribution savings.

In general, in another aspect, the invention features an interactive health insurance risk evaluation application stored in a first computing device and adapted to be accessed by a user via a second computing device connecting to the first computing device via a network connection. The risk evaluation application includes a first webpage and a second webpage adapted to be viewed by the user through a browser executing on the second computing device. The first webpage prompts the user to select a health plan that covers an individual or a family, then to select an amount of upfront claims cost responsibility (CCR) the user is willing to assume for the selected health plan and then to actuate determination of an amount of health plan premium contribution savings based on the selected health plan and CCR amount. The second webpage presents a first graph to the user depicting the CCR amount and a second graph depicting the determined amount of health plan premium contribution savings. The interactive health insurance risk evaluation application further includes computer implemented instructions stored in the first computing device for determining the health plan's premium contribution savings based on the selected CCR and the computer implemented instructions for determining the health plan's premium contribution savings based on the selected CCR comprise an algorithm that includes a three parameter logarithmic function of the CCR. The second webpage further comprises a first control for actuating acceptance of the selected health plan and CCR amount and then enrollment into the selected health plan. The interactive health insurance risk evaluation application further includes a third webpage also adapted to be viewed by the user through the browser. The third webpage presents a health plan enrollment form to the user. The second webpage further comprises a second control for selecting a different CCR amount and/or a different health plan.

In general, in another aspect, the invention features a display device rendering a first graphical user interface that includes a first row comprising a prompt to a user to select a health plan that covers an individual or a family, a second row comprising a prompt to select an amount of upfront claims cost responsibility (CCR) the user is willing to assume for the selected health plan and a control. Actuation of the control initiates determination of health plan premium contribution savings based on the selected health plan and CCR amount. The display device further renders a second graphical user interface that comprises a first graph depicting the CCR amount and a second graph depicting the determined amount of health plan premium contribution savings. The second graphical user interface further comprises a first control for actuating acceptance of the selected health plan and CCR amount and enrollment into the selected health plan. The second graphical user interface further comprises a second control for selecting a different CCR amount and/or a different health plan. The display device further renders a third graphical user interface that includes a health plan enrollment form. The first, second and third graphical user interfaces are implemented as first, second and third webpages accessed via a web browser.

Among the advantages of this invention may be one or more of the following. The risk evaluator application empowers each user to customize a unique health care plan so that it reflects that user's specific health profile, benefit budget and level of risk tolerance. This technology replaces the traditional “one size fits all” approach to health insurance. Today, most employers design a single health benefit package, or at most a small number of health benefit options, and offer that package or those options to all their employees on a “take it or leave it basis”. Employees are forced to choose between a plan that is often poorly suited to their needs and resources or no plan at all. With the risk evaluator application, employers can now permit each individual employee to design a health benefit plan that reflects that employee's overall health, financial resources and security priorities.

### BRIEF DESCRIPTION OF THE DRAWINGS

FIG. 1 depicts an online system for a health insurance risk evaluator;

FIG. 2 illustrates a block diagram of the health insurance risk evaluation process;

FIG. 3A depicts the step of selecting an individual or a family health plan in the process of FIG. 2;

FIG. 3B depicts the step of notifying the user about HSA eligibility in the process of FIG. 2;

FIG. 4A depicts the step of calculating the premium contribution savings based on the selected CCR in the process of FIG. 2;

FIG. 4B depicts the graph used to calculate the premium contribution savings based on the selected CCR in the process of FIG. 2; and

FIG. 5 depicts the health plan enrollment step in the process of FIG. 2.

### DETAILED DESCRIPTION OF THE INVENTION

Each employer who has access to the risk evaluator application begins by designing a health benefit plan that provides virtually 100% benefits for all covered services and conditions (some co-payments and service limitations may apply). The employer then determines and communicates the level of premium contribution that will be required of each employee who wishes to provide this 100% benefit for himself and his designated family members (if any).

Then, each employee has the option to use the risk evaluator application to determine how much that premium contribution would be reduced if that employee were willing to assume responsibility for a certain corridor of upfront claims (commonly called a “deductible”). A different level of contribution savings would be associated with each potential deductible amount. The user can use the risk evaluator application over and over until he is satisfied that he has arrived at a balance of premium savings and claims cost responsibility that is personally optimal. After the employee settles on the desired values, the risk evaluator application automatically transfers that election onto the employer's online enrollment form and the employee is directed to begin the actual enrollment process itself.

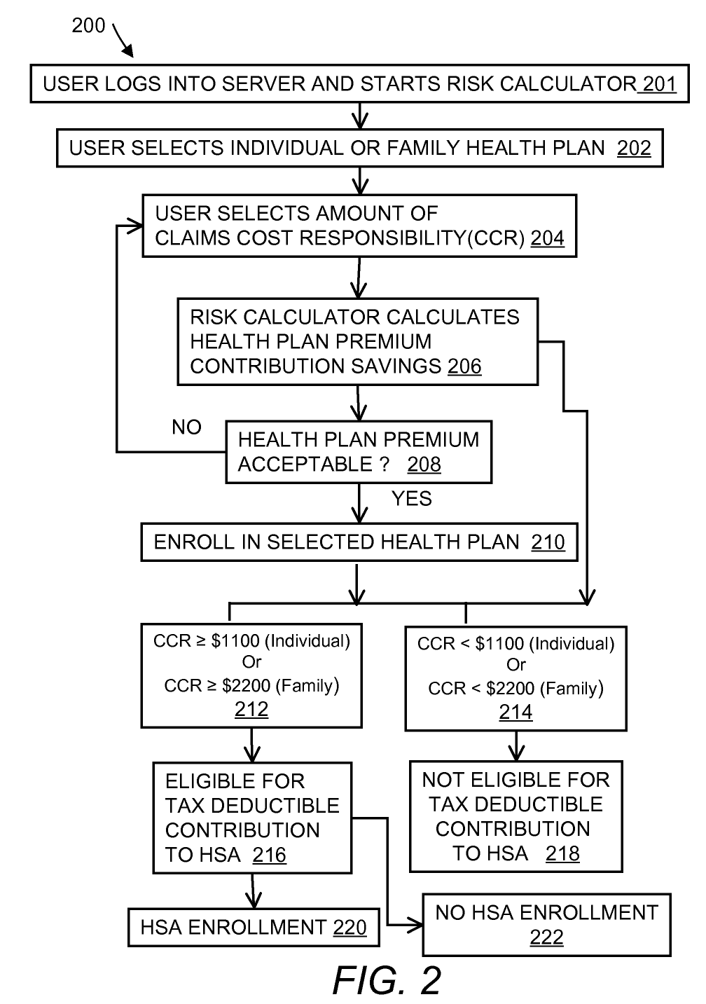

Referring to FIG. 2, the health insurance risk evaluation application 200 includes the following steps: First a user logs into a server hosting the risk evaluation application and starts the risk calculator (201). Next the user is prompted to select a health plan that covers an individual or a family (202). Next, the user selects the amount of claims cost responsibility (CCR) that he is willing to assume (204). The risk calculator then calculates the health plan premium contribution savings and presents it to the user (206). If the resulting health plan premium is acceptable to the user (208), the user enrolls in the selected health plan (210). If the resulting health plan premium is not acceptable to the user, the user goes back to step 204 where he changes the CCR amount and the calculation is repeated until the health plan premium is acceptable by the user. If the selected CCR amount is higher than a specific value (212) the user is notified that he is eligible for making tax-deductible contributions to an HSA account (216) and he chooses to either enroll in the HSA (220) or not (222). If the selected CCR amount is lower than a specific value (214) the user is notified that he is not eligible for making tax-deductible contributions to an HSA account (218). The specific value of the CCR amount that allows a user to enroll in an HSA account is $1100.00 for an individual or $2200.00 for a family for 2008.

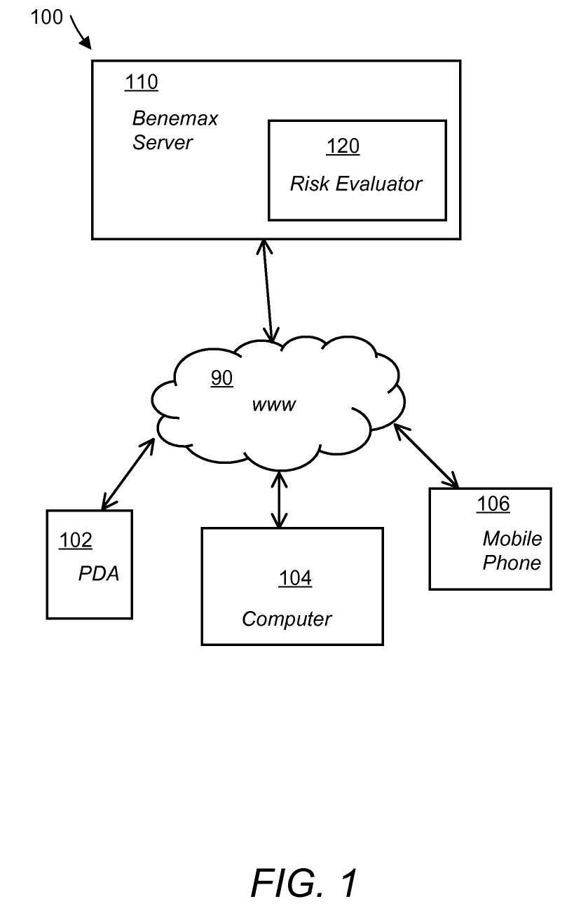

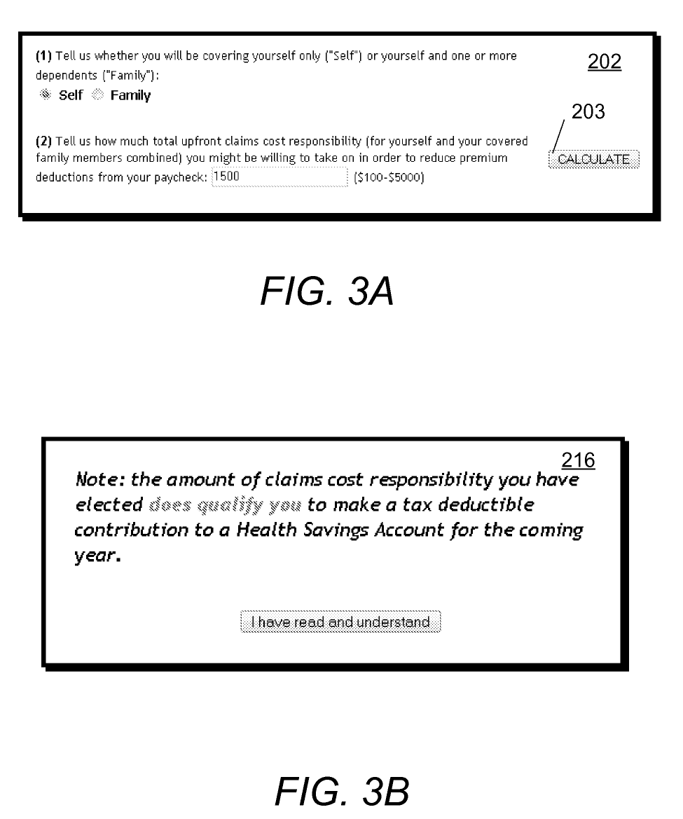

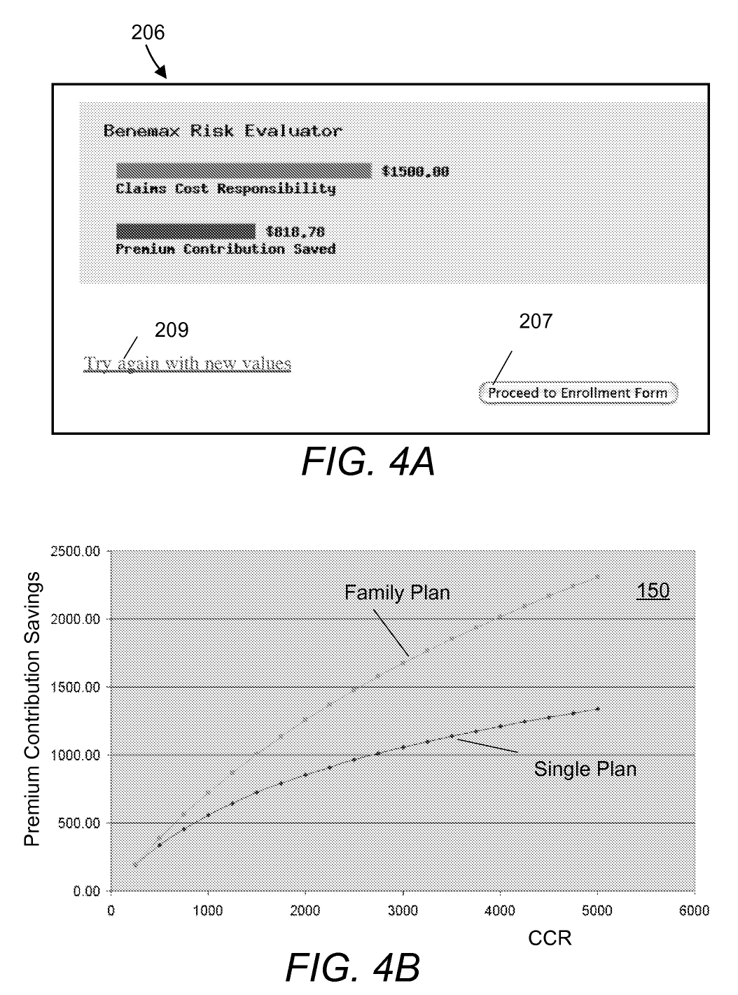

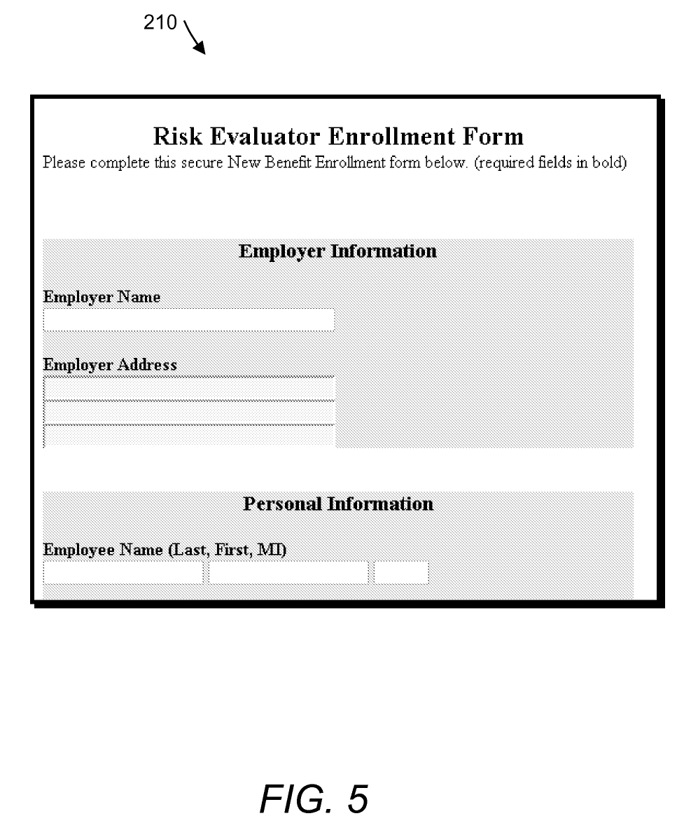

Referring to FIG. 1, the above-described process is executed on a system 100 including a server 110 accessible to personal computers 104, mobile phones 106, personal digital assistants (PDAs) 102, or other client devices via a network connection 90. Server 110 includes the risk evaluation application 120 that is remotely executed by the mentioned client devices. In one example, network 90 is the Internet and the user uses a computer 104 with a browser to establish a network connection to the server in order to execute the risk evaluation application 120. In other examples, the risk evaluator 120 is stored locally in the user's computer. Once the connection is established and the risk evaluator application is started, the application presents a first webpage 202 to the user, as shown in FIG. 3A. Here the user indicates whether the insurance plan is to cover self only or a family and then the user designates the level of claims cost responsibility (CCR) or risk he might be willing to assume. The application accommodates any dollar risk from a minimum of $250.00 to a maximum of $5,000.00 per year. If the selected CCR amount is higher than a specific value the user is notified that he is eligible for making tax-deductible contributions to an HSA account, as shown in FIG. 3B. Next, the user activates the “calculate” control 203 and the risk calculator calculates the health plan premium contribution savings and presents the result to the user as a graphic representation of claims cost responsibility selected, along with the associated savings in premium contribution cost, as shown in FIG. 4A. At this point, the user has the option to approve this selection and proceed to an enrollment form by activating control 207, or return to the risk evaluator application to evaluate an alternative risk/reward combination by activating control 209. If the resulting health plan premium is acceptable to the user, the user enrolls in the selected health plan with the numbers selected via the risk evaluator by filling out an enrollment form 210, shown in FIG. 5.

The calculation of the premium contribution savings is based on a model that takes into consideration the number of covered individuals (one for “self” selection and two or more for “family” selection), the underling health plan design and empirically determined data relating average claims utilization to various levels of deductible risk. Over the past 22 years, Benemax, Inc. has administered high deductible plans for more than 1,000 employers and more than 100,000 plan members. During this time Benemax, Inc has accumulated experience and data relating average claims utilization to various levels of deductible risk. This relationship can be consistently described by a three parameter logarithmic function. The specifics of that function evolve over time, as health care costs increase and more up to date claims experience becomes available. The specifics of the function are also influenced by details in the underlying health plan design, most significantly, the inventory of covered services that are applied toward the deductible. In some cases the unique characteristics of an individual employer such as industry type, demographics, prior claims history, and location, among others, could alter the details of the function. Health plan covered services may also be affected by government or other regulatory mandates and these mandates may also influence the specifics of the functional relationship between CCR and premium contributions saved. The calculation of the premium contribution savings is usually based on the three parameter logarithmic function, shown in FIG. 4B. In one example, the function for a plan covering a single individual is:

Output=(natural log(723.54+Input)×648.223−4273.54),

and for a plan covering a family is:

Output=(natural log(723.54+(Input/3))×648.223×4273.54)×3.

“Output” is the calculated premium contribution savings and “Input” is the CCR amount. These functions were determined based on a set of data including 1822 actual points. Benemax, Inc. shares its overall professional experience with its clients and then helps them evaluate unique plans or company characteristics that could vary the terms of the three parameter logarithmic function for that situation. Once they have determined the precise terms of the three parameter logarithmic function that best fits that employer's plan design and circumstances, they advise that employer to offer each of its employees access to the risk evaluator application so that each employee can elect a balance of deductible responsibility and premium cost that best reflects that employee's needs, resources and values. As a result, on average, the employer's overall plan cost is unaffected by the specific choices its employees make. Reductions in employee contributions are, again on average, reflected and offset by reductions in the employer's claims cost. However, over all of these variables, experience consistently approximates the three parameter logarithmic relationship.

In one example, the risk evaluator application is created with HTML and CSS, PHP scripting for the dynamic pages, running on Microsoft IIS web server. All pages are encrypted using SSL from Thawte Consulting and all data filled in the enrollment form are stored in a MySQL database. Upon completion of the enrollment form, an email notification is sent to an enrollment specialist.

Several embodiments of the present invention have been described. Nevertheless, it will be understood that various modifications may be made without departing from the spirit and scope of the invention. Accordingly, other embodiments are within the scope of the following claims.

What is claimed is:

1. A computer implemented method for selecting a health plan comprising:
logging into a server comprising a risk evaluation application and starting said risk evaluation application;
upon being prompted by said risk evaluation application selecting a health plan for an individual or for a family;
upon being prompted by said risk evaluation application selecting an amount of upfront claims cost responsibility (CCR) willing to assume;
actuating a control for determining health plan premium contribution savings;
determining said health plan premium contribution savings based on said selected health plan and said selected CCR; and
displaying said selected CCR and said determined health plan premium contribution savings.

2. The computer implemented method of claim 1 further comprising accepting said selected health plan based on said determined health plan premium savings and enrolling into said selected health plan by filling out an electronic health plan enrollment form.

3. The computer implemented method of claim 1 further comprising rejecting said selected health plan based on said determined health plan premium savings, then selecting a different amount of upfront CCR, and then determining again the health plan premium contribution savings.

4. The computer implemented method of claim 1 further comprising determining eligibility for tax deductible contribution to a health savings account based on the selected CCR.

5. The computer implemented method of claim 1 wherein said determining of said health plan premium contribution savings comprises executing an algorithm comprising a three parameter logarithmic function of said selected CCR amount.

6. The computer implemented method of claim 1 wherein said displaying of said selected CCR and said determined health plan premium contribution savings comprise presenting a first graph depicting said selected CCR and a second graph depicting said determined health plan premium contribution savings.

7. A computer system comprising a first computing device, a storage device and a computer program stored in said storage device, wherein said computer program comprises:
a first webpage adapted to be viewed by a user through a browser executing on a second computing device, wherein said second computing device is adapted to connect to said first computing device via a network connection, wherein said first webpage prompts said user to select a health plan that covers an individual or a family, then to select an amount of upfront claims cost responsibility (CCR) the user is willing to assume for the selected health plan and then to actuate determination of an amount of health plan premium contribution savings based on the selected health plan and the selected CCR amount;
a second webpage also adapted to be viewed by said user through said browser, wherein said second webpage presents a first graph to said user depicting said CCR amount and a second graph depicting said determined amount of health plan premium contribution savings.

8. The computer system of claim 7 wherein said computer program further comprises computer implemented instructions for determining said health plan's premium contribution savings based on said selected CCR.

9. The computer system of claim 8 wherein said computer implemented instructions for determining said health plan's premium contribution savings based on said selected CCR comprise an algorithm, said algorithm comprising a three parameter logarithmic function of said CCR.

10. The computer system of claim 9 wherein said second webpage further comprises a first control for actuating acceptance of the selected health plan and CCR amount and enrollment into the selected health plan.

11. The computer system of claim 10 further comprising a third webpage also adapted to be viewed by said user through said browser, wherein said third webpage presents a health plan enrollment form to said user.

12. The computer system of claim 10 wherein said second webpage further comprises a second control for selecting a different CCR amount and/or a different health plan.

13. An interactive health insurance risk evaluation application stored in a first computing device and adapted to be accessed by a user via a second computing device connecting to said first computing device via a network connection comprising:
a first webpage adapted to be viewed by said user through a browser executing on said second computing device, wherein said first webpage prompts said user to select a health plan that covers an individual or a family, then to select an amount of upfront claims cost responsibility (CCR) the user is willing to assume for the selected health plan and then to actuate determination of an amount of health plan premium contribution savings based on the selected health plan and CCR amount;
a second webpage also adapted to be viewed by said user through said browser, wherein said second webpage presents a first graph to said user depicting said CCR amount and a second graph depicting said determined amount of health plan premium contribution savings.

14. The interactive health insurance risk evaluation application of claim 13, further comprising computer implemented instructions stored in said first computing device for determining said health plan's premium contribution savings based on said selected CCR.

15. The interactive health insurance risk evaluation application of claim 14 wherein said computer implemented instructions for determining said health plan's premium contribution savings based on said selected CCR comprise an algorithm and said algorithm comprises a three parameter logarithmic function of said CCR.

16. The interactive health insurance risk evaluation application of claim 14 wherein said second webpage further comprises a first control for actuating acceptance of the selected health plan and CCR amount and then enrollment into the selected health plan.

17. The interactive health insurance risk evaluation application of claim 16 further comprising a third webpage also adapted to be viewed by said user through said browser, wherein said third webpage presents a health plan enrollment form to said user.

18. The interactive health insurance risk evaluation application of claim 16 wherein said second webpage further comprises a second control for selecting a different CCR amount and/or a different health plan.

19. A display device rendering a first graphical user interface wherein the first graphical user interface comprises:
a first row comprising a prompt to a user to select a health plan that covers an individual or a family, a second row comprising a prompt to select an amount of upfront claims cost responsibility (CCR) the user is willing to assume for the selected health plan and a control, wherein actuation of said control initiates determination of health plan premium contribution savings based on the selected health plan and CCR amount.

20. The display device of claim 19 wherein said control is a link to an algorithm that determines said health plan premium contribution savings based on said selected health plan and CCR and said algorithm comprises a three parameter logarithmic function of said CCR.

21. The display device of claim 19 further rendering a second graphical user interface wherein said second interface comprises a first graph depicting said CCR amount and a second graph depicting said determined amount of health plan premium contribution savings.

22. The display device of claim 21 wherein said second graphical user interface further comprises a first control for actuating acceptance of the selected health plan and CCR amount and enrollment into the selected health plan.

23. The display device of claim 22 wherein said second graphical user interface further comprises a second control for selecting a different CCR amount and/or a different health plan.

24. The display device of claim 22 further rendering a third graphical user interface, wherein said third graphical user interface comprises a health plan enrollment form.

25. The display device of claim 24 wherein said first, second and third graphical user interfaces are implemented as first, second and third webpages accessed via a web browser.
